(19) United States
(12) Patent Application Publication
(10) Pub. No.: US 2025/0383804 A1
(43) Pub. Date: Dec. 18, 2025

(54) MEMORY MANAGEMENT METHOD AND MEMORY CONTROLLER

(71) Applicant: Hosin Global Electronics Co., LTD, Shenzhen (CN)

(72) Inventors: Hao Wang, Shenzhen (CN); Tsung-Lin Wu, Hsinchu City (TW); Chao-Yu Chen, Shenzhen (CN); Jie Zhang, Shenzhen (CN); Wei Wang, Shenzhen (CN); Qi Ming Zhu, Shenzhen (CN); Xiao Min Chen, Shenzhen (CN); Jing Wan, Shenzhen (CN); Yuan Hong Ye, Shenzhen (CN); Hai Liang Wu, Shenzhen (CN); Kai Qiang Meng, Shenzhen (CN)

(73) Assignee: Hosin Global Electronics Co., LTD, Shenzhen (CN)

(21) Appl. No.: 19/019,470

(22) Filed: Jan. 14, 2025

(30) Foreign Application Priority Data
Jun. 14, 2024 (CN) 202410764367.4

(51) Int. Cl. G06F 3/06

(52) U.S. Cl. CPC G06F 3/064; G06F 3/0604; G06F 3/0655; G06F 3/0679

(57) ABSTRACT

A memory management method and a memory controller using the same are provided. The memory management method includes: selecting a target bad block from one or a plurality of bad blocks of a rewritable non-volatile memory module to write first data; reading the target bad block to obtain second data, and comparing the first data and the second data to determine one or more error byte positions; establishing a bad byte table according to the one or more error byte positions; resetting a plurality of physical addresses of a plurality of storage units owned by each bad block of a target plane to which the target bad block belongs according to the bad byte table; and setting bad blocks of the target plane as normal physical blocks to store data.

### CROSS-REFERENCE TO RELATED APPLICATION

This application claims the priority benefit of China application serial no. 202410764367.4, filed on Jun. 14, 2024. The entirety of the above-mentioned patent application is hereby incorporated by reference herein and made a part of this specification.

### BACKGROUND

### Technical Field

The present invention relates to a memory management technology, particularly to a memory controller adapted for controlling a storage device disposed with a non-volatile memory and a memory management method used by the memory controller.

### Description of Related Art

Non-volatile memory is a computer memory that can retain stored data even when power is removed. It has advantages such as data non-volatility, power saving, small size and no mechanical structure, and is widely used in various electronic devices.

However, due to process limitations of NAND flash memory, repeatedly erasing and writing to the same physical block or using it for too long can easily result in block damage, causing errors in stored data. Therefore, when using NAND flash memory, bad block management must be performed. When uncorrectable bad blocks occur, they are discarded and data is saved to good blocks in the NAND flash memory. However, when the NAND flash memory generates more and more bad blocks due to usage time or imperfect FTL algorithms causing certain physical blocks to reach their lifespan more quickly, it will eventually lead to insufficient good blocks in the storage product and make it unusable. Existing bad block management schemes all waste a large amount of usable storage space and urgently need improvement.

### SUMMARY

The present invention aims to solve the above-mentioned problems by detecting/predicting bad storage units in physical blocks in advance, resetting physical addresses of a plurality of storage units of each bad block, so as to avoid the probability of data storage errors, recycling each bad block as a normal physical block to store data, improving the utilization of storage space and enhancing the stability and operation efficiency of the storage device.

One or more embodiments of the present invention provide a memory management method, comprising: selecting a target bad block from one or a plurality of bad blocks of a rewritable non-volatile memory module to write first data; obtaining second data from the target bad block, and comparing the first data and the second data to determine one or more error byte positions; establishing a bad byte table according to the one or more error byte positions; resetting a plurality of physical addresses of a plurality of storage units owned by each bad block of a target plane to which the target bad block belongs according to the bad byte table; and setting each bad block of the reset target plane as a normal physical block to store data.

In one or more embodiments of the present invention, wherein the rewritable non-volatile memory module has a plurality of planes, and the processor selects the target bad block from each plane to establish the bad byte table corresponding to each plane.

In one or more embodiments of the present invention, wherein the target bad block is selected by a random manner, wherein content of the first data is a plurality of predetermined bit values, and the plurality of bit values are set to be one of following patterns: all being a same first value or second value; and the first value and the second value being randomly arranged.

In one or more embodiments of the present invention, further comprising: writing a plurality of first data with different patterns to the target bad block, obtaining a plurality of second data corresponding to the plurality of first data from the target bad block to obtain a plurality of groups of error byte positions corresponding to the plurality of first data; analyzing the plurality of groups of error byte positions to determine whether an error byte pattern of the target bad block is a regular pattern or an irregular pattern; and establishing the bad byte table according to the plurality of groups of error byte positions and the error byte pattern.

In one or more embodiments of the present invention, determining the error byte pattern as the regular pattern if address differences between adjacent two error byte positions in each group of error byte positions are all a fixed value; and determining the error byte pattern as the irregular pattern if address differences between adjacent two error byte positions in each group of error byte positions are not a fixed value.

In one or more embodiments of the present invention, if the error byte pattern is the regular pattern, in the operation of establishing the bad byte table according to the plurality of groups of error byte positions and the error byte pattern, establishing the bad byte table according to a first error byte position in each group of error byte positions and the fixed value.

In one or more embodiments of the present invention, if the error byte pattern is the irregular pattern, in the operation of establishing the bad byte table according to the plurality of groups of error byte positions and the error byte pattern: counting a total number of occurrences of each error byte position in the plurality of groups of error byte positions; according to the total number of each error byte position, sorting all error byte positions in descending order; and selecting at most N error byte positions from a plurality of sorted error byte positions to record in a bitmap corresponding to the target plane to establish the bad byte table, wherein N is a predetermined redundant byte number.

In one or more embodiments of the present invention, further comprising: recording the total number of each error byte position, obtaining one or more target error byte positions having the total number greater than a first threshold according to the bitmap and the total number of each error byte position.

In one or more embodiments of the present invention, further comprising: in the operation of resetting the plurality of physical addresses of the plurality of storage units owned by each bad block of the target plane to which the target bad block belongs according to the bad byte table, comparing a plurality of physical addresses already set to the plurality of storage units and the one or more target error byte positions to obtain one or more first physical addresses corresponding to the one or more target error byte positions and a plurality of second physical addresses not corresponding to the one or more target error byte positions; sequentially setting the plurality of second physical addresses and one or more third physical addresses to the plurality of storage units, wherein the one or more third physical addresses belong to a plurality of redundant physical addresses of a redundant area of each physical block.

In one or more embodiments of the present invention, according to a total number of one or more fourth physical addresses that are not the one or more third physical addresses among the plurality of redundant physical addresses, upgrading a first error correction capability of each physical block of the target plane to a second error correction capability, so as to adjust a size of generated error correction data from a first size to a second size.

One or more embodiments of the present invention provide a memory controller adapted for controlling a storage device disposed with a rewritable non-volatile memory module. The memory controller comprises: a memory interface control circuit, configured to electrically connect to the rewritable non-volatile memory module; and a processor, electrically connected to the memory interface control circuit, wherein the processor is further electrically connected to a connection interface circuit of the storage device for electrically connecting to a host system. The processor is configured to: select a target bad block of the rewritable non-volatile memory module to write first data; obtain second data from the target bad block and compare the first data and the second data to determine one or more error byte positions; establish a bad byte table according to the one or more error byte positions; reset a plurality of physical addresses of a plurality of storage units owned by each bad block of a target plane to which the target bad block belongs according to the bad byte table; and set each bad block of the reset target plane as a normal physical block to store data.

Based on the above, the memory controller and memory management method provided by the embodiments of the present invention can find error byte positions of each physical block to establish a bad byte table, and reset a plurality of physical addresses of each physical block according to the bad byte table, so as to make the reset physical block have more stable physical addresses, thereby enhancing the stability of stored data and further avoiding the occurrence of error data, reducing the burden of error correction. Furthermore, the reset bad blocks are recycled to increase storage space. As can be seen, the present invention significantly improves the storage space utilization efficiency of the storage device and greatly enhances the overall working efficiency.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a host system and a storage device according to an embodiment of the present invention.

FIG. 2 is a flowchart of a memory management method according to an embodiment of the present invention.

FIG. 3 is a diagram illustrating determination of one or more error byte positions according to an embodiment of the present invention.

FIG. 4 is a diagram illustrating establishment of a bad byte table according to an embodiment of the present invention.

FIG. 5 is a diagram illustrating determination of one or more error byte positions according to another embodiment of the present invention.

FIG. 6 is a diagram illustrating establishment of a bad byte table according to another embodiment of the present invention.

FIG. 7 is a diagram illustrating resetting of a plurality of physical addresses of a plurality of storage units owned by each bad block according to the bad byte table according to an embodiment of the present invention.

FIG. 8 is a diagram illustrating resetting of a plurality of physical addresses of a plurality of storage units owned by each bad page according to the bad byte table according to another embodiment of the present invention.

FIG. 9 is a diagram illustrating sorting of a plurality of error byte positions according to an embodiment of the present invention.

### DESCRIPTION OF THE EMBODIMENTS

Reference will now be made in detail to exemplary embodiments of the invention, examples of which are illustrated in the accompanying drawings. Wherever possible, the same reference numbers are used in the drawings and the description to refer to the same or like parts.

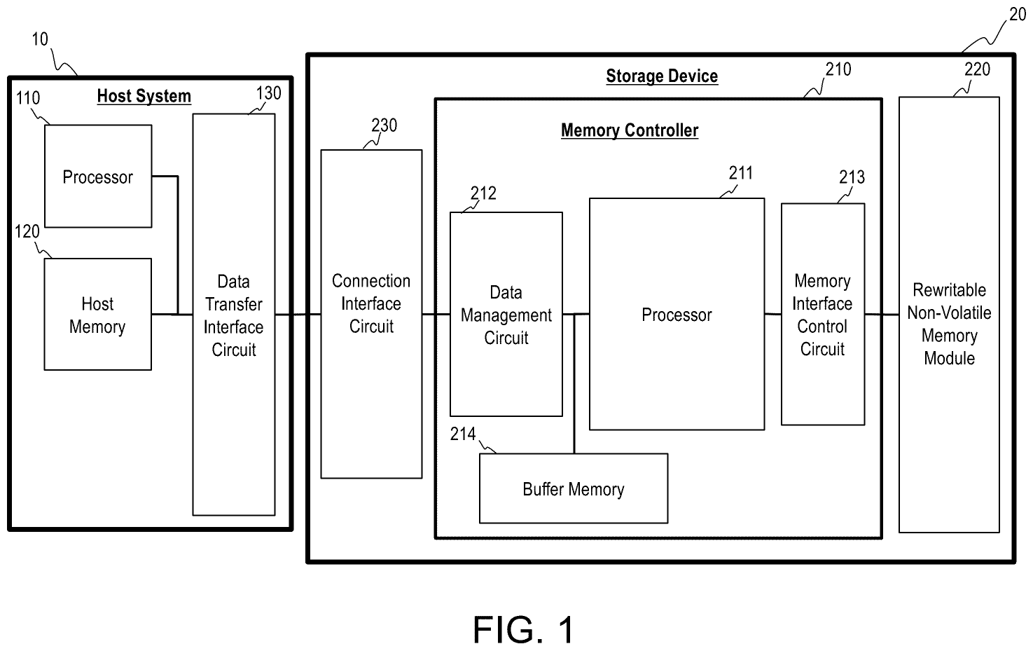

FIG. 1 is a block diagram of a host system and a storage device according to an embodiment of the present invention. Please refer to FIG. 1, the host system 10 is, for example, a personal computer, a notebook computer, or a server. The host system 10 includes a processor 110 (also called, a second processor), a host memory 120, and a data transfer interface circuit 130. In this embodiment, the processor 110 is coupled (also called, electrically connected) to the host memory 120 and the data transfer interface circuit 130. In another embodiment, the processor 110, the host memory 120, and the data transfer interface circuit 130 are electrically connected to each other through a system bus. In this embodiment, the processor 110, the host memory 120, and the data transfer interface circuit 130 can be disposed on a motherboard of the host system 10.

The storage device 20 includes a memory controller 210, a rewritable non-volatile memory module 220, and a connection interface circuit 230. The memory controller 210 includes a processor 211 (also called, a first processor), a data management circuit 212, and a memory interface control circuit 213.

In this embodiment, the host system 10 performs data access operations with the storage device 20 through electrical connection between the data transfer interface circuit 130 and the connection interface circuit 230 of the storage device 20. For example, the host system 10 may store data to the storage device 20 or read data from the storage device 20 through the data transfer interface circuit 130.

In this embodiment, the number of the data transfer interface circuit 130 can be one or more. Through the data transfer interface circuit 130, the motherboard may be electrically connected to the storage device 20 through wired or wireless manner. The storage device 20 can be, for example, a USB flash drive, a memory card, a solid state drive (SSD), or a wireless memory storage device. The wireless memory storage device can be, for example, a near field communication (NFC) memory storage device, a WiFi memory storage device, a Bluetooth memory storage device, or a low power Bluetooth memory storage device (for example, iBeacon) or other memory storage devices based on various wireless communication technologies. In addition, the motherboard can also be electrically connected to various I/O devices such as a global positioning system (GPS) module, a network interface card, a wireless transmission device, a keyboard, a screen, and speakers through the system bus.

In this embodiment, the data transfer interface circuit 130 and the connection interface circuit 230 are interface circuits compatible with the Peripheral Component Interconnect Express (PCI Express) standard. Moreover, data transmission between the data transfer interface circuit 130 and the connection interface circuit 230 is performed using the Non-Volatile Memory express (NVMe) communication protocol.

In addition, in another embodiment, the connection interface circuit 230 may be packaged with the memory controller 210 in one chip, or the connection interface circuit 230 is disposed outside a chip containing the memory controller 210.

In this embodiment, the host memory 120 is used to temporarily store instructions or data executed by the processor 110. For example, in this embodiment, the host memory 120 can be Dynamic Random Access Memory (DRAM), Static Random Access Memory (SRAM), etc. However, it must be understood that the present invention is not limited to this, and the host memory 120 can also be other suitable memories.

The memory controller 210 is used to execute multiple logic gates or control instructions implemented in hardware form or firmware form and perform operations such as writing, reading, and erasing data in the rewritable non-volatile memory module 220 according to instructions from the host system 10.

More specifically, the processor 211 in the memory controller 210 is hardware with computational capability, used to control the overall operation of the memory controller 210. Specifically, the processor 211 is programmed by multiple control instructions/program codes, and when the storage device 20 operates, these control instructions/program codes are executed to perform operations such as writing, reading, and erasing data. Furthermore, in this embodiment, the control instructions/program codes can also be executed to perform data reading operations to implement the data reading method provided by the present invention. The control instructions/program codes corresponding to the data reading method can also be implemented as hardware circuit units to implement the data reading method provided by the present invention.

It is worth mentioning that in this embodiment, the processor 110 and the processor 211 are, for example, a central processing unit (CPU), a micro-processor, or other programmable processing units (Microprocessor), digital signal processor (Digital Signal Processor, DSP), programmable controller, application specific integrated circuits (Application Specific Integrated Circuits, ASIC), programmable logic device (Programmable Logic Device, PLD) or other similar circuit components, the present invention is not limited to this.

In this embodiment, as mentioned above, the memory controller 210 also includes the data management circuit 212 and the memory interface control circuit 213. It should be noted that operations executed by each component of the memory controller 210 can also be considered as operations executed by the memory controller 210.

Among them, the data management circuit 212 is electrically connected to the processor 211, the memory interface control circuit 213, and the connection interface circuit 230. The data management circuit 212 is used to accept instructions from the processor 211 to perform data transmission. For example, reading data from the host system 10 (e.g., host memory 120) through the connection interface circuit 230, and writing the read data to the rewritable non-volatile memory module 220 through the memory interface control circuit 213 (e.g., performing write operation according to write instruction from the host system 10). Another example is reading data from one or more physical units in the rewritable non-volatile memory module 220 (data can be read from one or more storage units in one or more physical units) through the memory interface control circuit 213, and writing the read data to the host system 10 (e.g., host memory 120) through the connection interface circuit 230 (e.g., performing read operation according to read instruction from the host system 10). In another embodiment, the data management circuit 212 can also be integrated into the processor 211.

The memory interface control circuit 213 is used to accept instructions from the processor 211 and cooperate with the data management circuit 212 to perform writing (also called programming) operations, reading operations, or erasing operations on the rewritable non-volatile memory module 220.

Furthermore, data to be written to the rewritable non-volatile memory module 220 is converted through the memory interface control circuit 213 into a format acceptable by the rewritable non-volatile memory module 220. Specifically, when the processor 211 needs to access the rewritable non-volatile memory module 220, the processor 211 transmits corresponding instruction sequences to the memory interface control circuit 213 to instruct the memory interface control circuit 213 to execute corresponding operations. For example, these instruction sequences may include write instruction sequences for instructing data writing, read instruction sequences for instructing data reading, erase instruction sequences for instructing data erasing, and corresponding instruction sequences for instructing various memory operations. These instruction sequences may include one or more signals, or data on the bus. These signals or data may include instruction codes or program codes. For example, a read instruction sequence will include information such as read identification code, memory address, physical address, etc.

Furthermore, the memory controller 210 establishes a logical to physical address mapping table and a physical to logical address mapping table to record the mapping relationship between logical addresses of logical units (such as logical blocks, logical pages) and physical addresses of physical units (such as physical erase units/physical blocks, physical pages) configured for the rewritable non-volatile memory module 220. In other words, the memory controller 210 may use the logical to physical address mapping table (also called the logical to physical mapping table) to find the physical unit mapped by a logical unit (such as finding the physical page mapped by a logical page; finding the physical address mapped by a logical address), and the memory controller 210 may use the physical to logical address mapping table (also called the physical to logical mapping table) to find the logical unit mapped by a physical unit (such as finding the logical page mapped by a physical page; finding the logical address mapped by a physical address).

In one embodiment, the memory controller 210 also includes a buffer memory 214. The buffer memory is electrically connected to the processor 211 and is used to temporarily store data and instructions from the host system 10, data from the rewritable non-volatile memory module 220, or other system data (such as various mapping tables, index tables, bad byte tables, bad unit tables) for managing the storage device 20, allowing the processor 211 to quickly access said data, instructions, or system data from the buffer memory 216.

The rewritable non-volatile memory module 220 is electrically connected to the memory controller 210 (memory interface control circuit 213) and is used to store user data sent by the host system 10.

In this embodiment, each memory die (chip) of multiple memory dies in the rewritable non-volatile memory module 220 has multiple planes, and each plane has multiple physical blocks. Each physical block includes multiple physical programming units (also called physical pages). Each physical page has multiple storage units (also called physical bytes or bytes), and each storage unit corresponds to a physical address. The physical address is used to record the physical location of data stored in the storage unit. It should be noted that the present invention does not limit the size of each physical page and logical page. Each byte has a size of 8 bits, used to store data of 8 bit values.

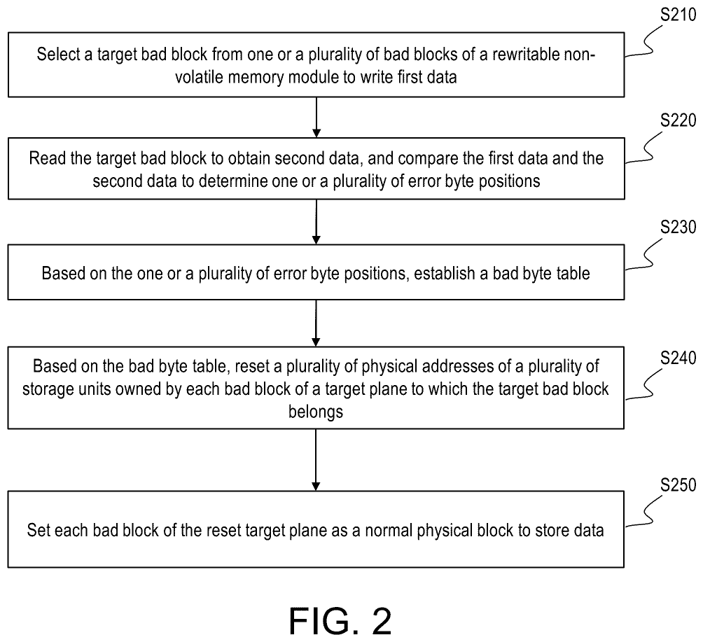

FIG. 2 is a flowchart of a memory management method according to an embodiment of the present invention.

Please refer to FIG. 2, in step S210, the memory controller 210 selects a target bad block from one or a plurality of bad blocks of the rewritable non-volatile memory module 220 to write first data. Then, in step S220, the memory controller 210 reads the target bad block to obtain second data, and compares the first data and the second data to determine one or more error byte positions.

Specifically, since physical blocks belonging to the same plane have similar physical characteristics, physical blocks within the same plane often exhibit consistent characteristics. By sampling one bad block in the same plane and obtaining error byte positions, it can be applied to all bad blocks in that plane. Therefore, the memory controller 210 selects one bad block (e.g., target bad block) from each plane according to the bad block table to establish the bad byte table corresponding to each plane (and determine the error byte pattern of the target plane to which the target bad block belongs). The bad byte table can record the distribution characteristics of bad bytes of the corresponding plane.

To establish the bad byte table, the memory controller 210 needs to first confirm the error byte positions corresponding to this plane.

In one embodiment, the memory controller 210 may select the target bad block by a random manner from multiple bad blocks recorded in the bad block table corresponding to one plane.

After selecting the target bad block, the memory controller 210 writes first data (also called test data) to the target bad block. In one embodiment, content of the first data is a plurality of predetermined bit values, and the plurality of bit values are set to be one of following patterns: all being a same first value (e.g., 0) or second value (e.g., 1); and the first value and the second value being randomly arranged. The size of the first data matches the storage space of the target bad block. That is, the user data area of the target bad block will be filled with first data.

Then, the memory controller 210 reads data stored in the target bad block (also called second data or data to be verified). Since the content of the first data is predetermined known data, the memory controller 210 may confirm the erroneous data and the position of its corresponding byte (also called error byte position) by comparing the read second data with the first data.

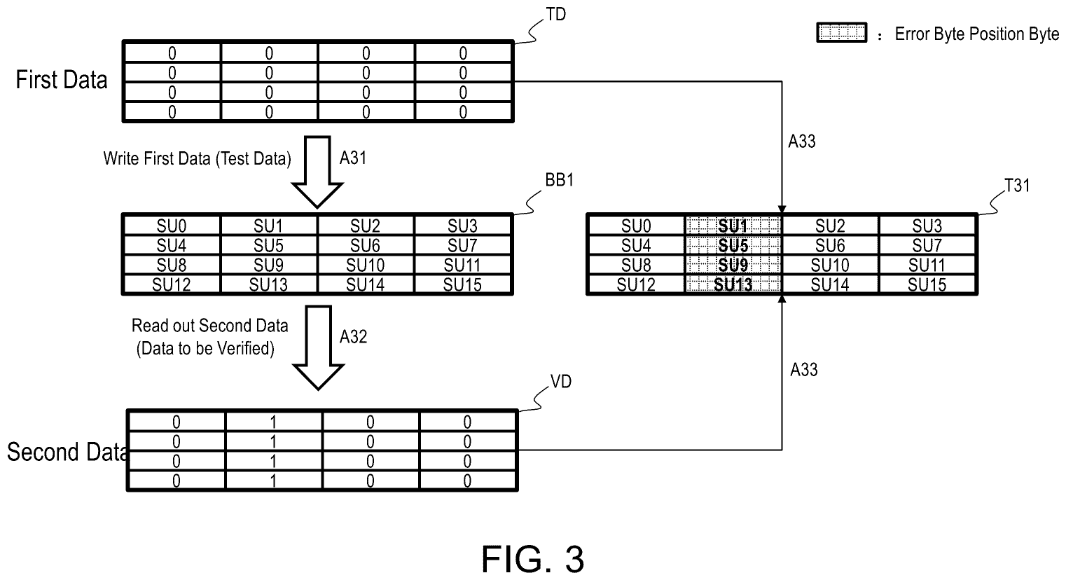

FIG. 3 is a diagram illustrating determination of one or more error byte positions according to an embodiment of the present invention. For example, please refer to FIG. 3, as indicated by arrow A31, the memory controller 210 writes first data TD to a target bad block BB1 in one plane. For ease of explanation, assume the target bad block BB1 has multiple storage units (e.g., bytes) SU0-SU15, first data TD may fill storage units SU0-SU15, and each bit value of the first data TD is “0”. Then, as indicated by arrow A32, the memory controller 210 reads second data VD from storage units SU0˜SU15. The first data TD and second data VD may be stored in the buffer memory 214.

Then, as indicated by arrow A33, the memory controller 210 compares first data TD and second data VD to determine that data stored in storage units SU1, SU5, SU9, SU13 has errors (as shown in table T31, obtaining error bytes SU1, SU5, SU9, SU13). Then, the memory controller 210 may obtain error byte positions according to physical addresses corresponding to error bytes SU1, SU5, SU9, SU13.

Please return to FIG. 2, then, in step S230, the memory controller 210 establishes a bad byte table according to the one or more error byte positions.

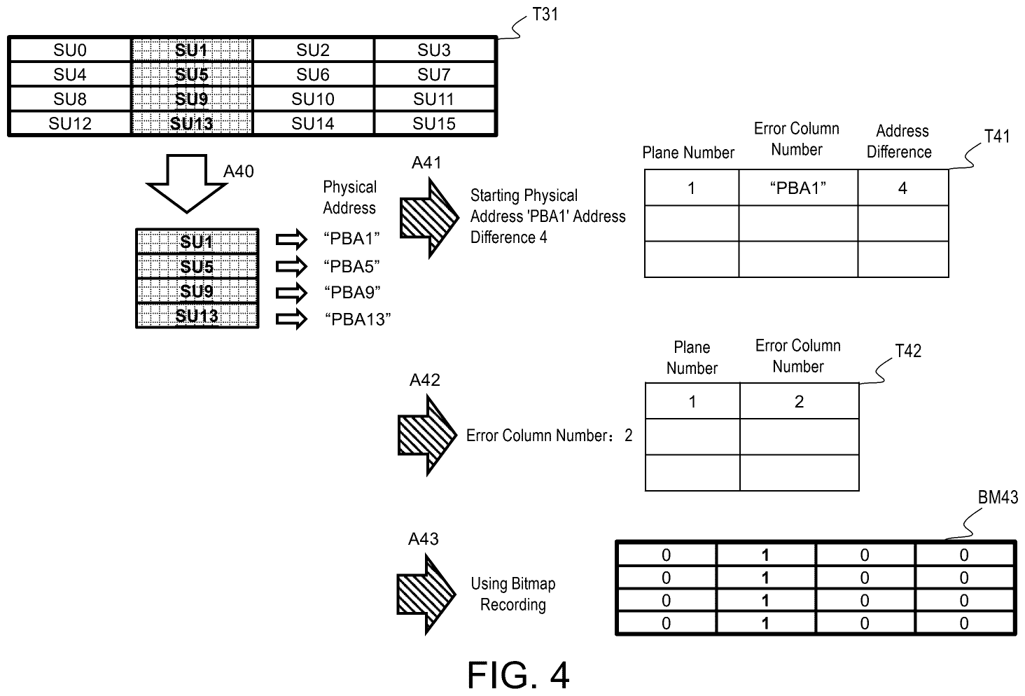

FIG. 4 is a diagram illustrating establishment of a bad byte table according to an embodiment of the present invention. For example, please refer to FIG. 4, continuing the example from FIG. 3, as indicated by arrow A40, the memory controller 210 may obtain multiple error byte positions “PBA1”, “PBA5”, “PBA9”, “PBA13” according to physical addresses corresponding to error bytes SU1, SU5, SU9, SU13.

In this example, since the address differences between adjacent error byte positions among multiple error byte positions “PBA1”, “PBA5”, “PBA9”, “PBA13” are a fixed value (e.g., 4), the memory controller 210 determines that the error byte pattern of target bad block BB1 is a regular pattern (e.g., errors occur every 4 physical addresses, and the starting physical address is “PBA1”).

In one embodiment, if the error byte pattern is the regular pattern, in the operation of establishing the bad byte table according to the plurality of groups of error byte positions and the error byte pattern, the memory controller 210 establishes the bad byte table according to a first error byte position in each group of error byte positions and the fixed value.

For example in FIG. 4, as indicated by arrow A41, the memory controller 210 establishes bad byte table T41 according to the determined error byte pattern (regular pattern) and multiple error byte positions. The bad byte table T41 includes 3 fields: plane number, starting physical address, address difference. Then, the memory controller 210 respectively records “1” (assuming the plane number of the plane to which target bad block BB1 belongs is “1”), “PBA1” and “4” to bad byte table T41.

In one embodiment, as indicated by arrow A42, the memory controller 210 determines that error data all occurs in the second column, corresponding to column number “2”, according to multiple error byte positions “PBA1”, “PBA5”, “PBA9”, “PBA13”. Accordingly, the memory controller 210 establishes bad byte table T42, including 2 fields: plane number and error column number. In this example, the memory controller 210 respectively records “1” (assuming the plane number of the target plane is “1”) and “2” to bad byte table T42.

In one embodiment, as indicated by arrow A43, the memory controller 210 directly establishes a bitmap BM43 corresponding to table T31 according to multiple error byte positions “PBA1”, “PBA5”, “PBA9”, “PBA13”, wherein the number and arrangement position of storage cells in bitmap BM43 correspond to the number and arrangement position of storage units of the physical block. Furthermore, a bit value of “1” recorded in the storage cell is used to indicate that the corresponding storage unit/physical address has an error; a bit value of “0” recorded in the storage cell is used to indicate that the corresponding storage unit/physical address has no error. In this example, the memory controller 210 records “1” to corresponding storage cells in bitmap BMT43 based on multiple error byte positions “PBA1”, “PBA5”, “PBA9”, “PBA13” to establish corresponding bad byte table BM43. Similarly, the memory controller 210 may establish multiple bitmaps respectively corresponding to multiple planes, and the ordering of the multiple bitmaps may correspond to the order of plane numbers of the multiple planes.

It is worth mentioning that the storage space consumed by bad byte tables T41, T42 will be lower than the storage space consumed by bad byte table BM43, wherein the storage space consumed by bad byte table T42 will be lower than the storage space consumed by bad byte table T41.

In one embodiment, the memory controller 210 writes a plurality of first data with different patterns (e.g., the plurality of bit values of the first data are set to be one of following patterns: all being 0 or 1; and random values) to the target bad block, obtains a plurality of second data corresponding to the plurality of first data by reading the target bad block to obtain a plurality of groups of error byte positions corresponding to the plurality of first data. Then, the memory controller 210 analyzes the plurality of groups of error byte positions to determine whether the error byte pattern of the target bad block is a regular pattern or an irregular pattern. That is, through using multiple first data and read second data, the memory controller 210 may determine whether the distribution state of error byte positions of the target bad block is regular or irregular.

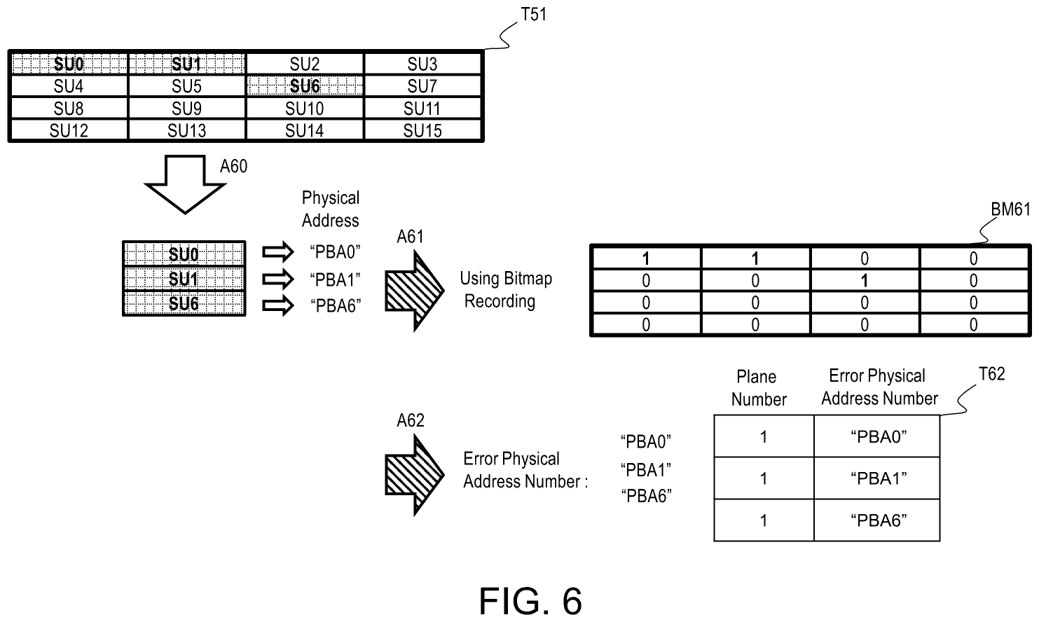

Next, the memory controller 210 establishes the bad byte table according to the plurality of groups of error byte positions and the error byte pattern. That is, after determining the distribution state of error byte positions of the target bad block, the memory controller 210 may use establishment methods of error byte positions corresponding to regular pattern and irregular pattern to establish corresponding bad byte table (can refer to examples in FIG. 4 and FIG. 6 respectively).

In one embodiment, if address differences between adjacent two error byte positions in each determined group of error byte positions are all a fixed value, the memory controller 210 determines the error byte pattern as the regular pattern. Conversely, if address differences between adjacent two error byte positions in each determined group of error byte positions are not a fixed value, the memory controller 210 determines the error byte pattern as the irregular pattern.

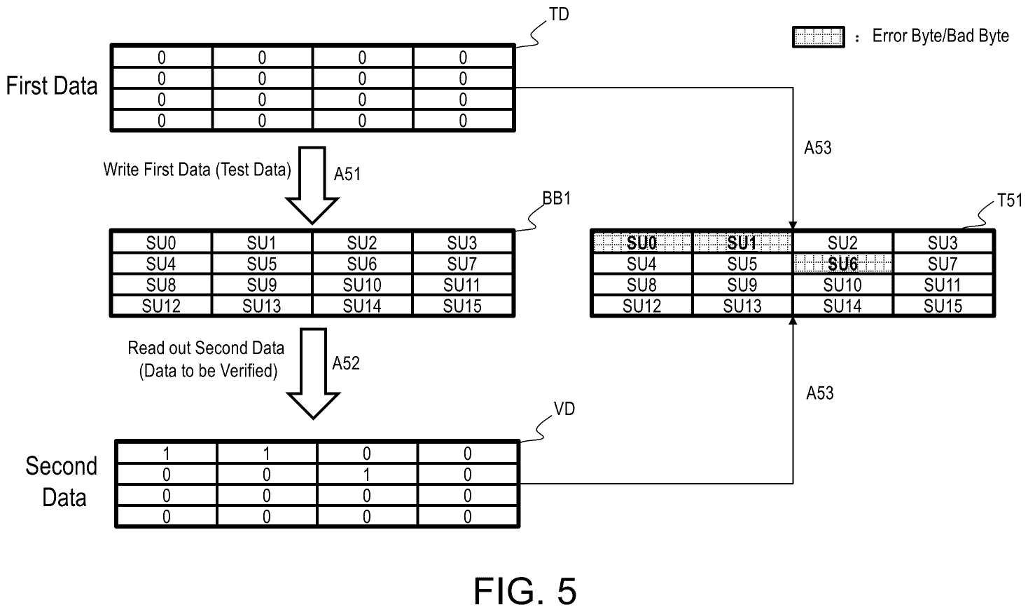

FIG. 5 is a diagram illustrating determination of one or more error byte positions according to another embodiment of the present invention. For example, please refer to FIG. 5, as indicated by arrow A51, the memory controller 210 writes first data TD to a target bad block BB1 in one plane. Then, as indicated by arrow A52, the memory controller 210 reads second data VD from storage units SU0˜SU15. The first data TD and second data VD may be stored in the buffer memory 214.

Then, as indicated by arrow A53, the memory controller 210 compares first data TD and second data VD to determine that data stored in storage units SU0, SU1, SU6 has errors (as shown in table T51, obtaining error bytes SU0, SU1, SU6). Then, the memory controller 210 may obtain error byte positions according to physical addresses corresponding to error bytes SU0, SU1, SU6.

FIG. 6 is a diagram illustrating establishment of a bad byte table according to another embodiment of the present invention. For example, please refer to FIG. 6, continuing the example from FIG. 5, as indicated by arrow A60, the memory controller 210 may obtain multiple error byte positions “PBA0”, “PBA1”, “PBA6” according to physical addresses corresponding to error bytes SU0, SU1, SU6. In this example, since address differences between adjacent error byte positions among multiple error byte positions “PBA0”, “PBA1”, “PBA6” are not a fixed value, the memory controller 210 determines that the error byte pattern of target bad block BB1 is an irregular pattern.

In one embodiment, if the error byte pattern is the irregular pattern, in the operation of establishing the bad byte table according to the plurality of groups of error byte positions and the error byte pattern, the memory controller 210 records multiple error byte positions to a bitmap corresponding to the target plane to establish the bad byte table.

In some cases, the number of multiple error byte positions recorded to the bitmap will be limited based on a predetermined redundant byte number, and the predetermined redundant byte number will be related to the error correction capability of the memory controller 210. More specifically, the error correction capability of the memory controller 210 may be adjusted to any value between a predetermined maximum value and a predetermined minimum value. Through the error correction capability corresponding to the predetermined maximum value, the memory controller 210 may generate X bytes of check data (also called error correction data) that may be used to correct errors within M bits; through the error correction capability corresponding to the predetermined minimum value, the memory controller 210 may generate Y bytes of check data (also called error correction data) that may be used to correct errors within N bits. The difference in the number of correctable error bits (M−N) is far smaller than the difference in the size of error correction data (X−Y). The predetermined redundant byte number is the difference between X and Y (predetermined redundant byte number=X−Y). For example, X is 200 bytes, Y is 100 bytes, M is 200 bits, Nis 100 bits.

Since using the highest error correction capability consumes (X−Y) more bytes of space to store larger error correction data, but the number of error data bits that may be error-corrected only increases by (M−N). Therefore, in this embodiment, when writing data, the memory controller 210 uses the error correction capability corresponding to the predetermined minimum value to generate error correction data to be stored together with the data to be stored to protect the stored data. Because using the minimum error correction capability limits the size of error correction data to the minimum, compared with the maximum error correction data, the saved space/bytes will be used to replace bad bytes. In this way, letting the saved bytes be used to replace physical addresses of error byte positions may further improve the overall data stability of physical blocks and achieve better storage space utilization efficiency.

Therefore, the total number of error byte positions recorded in the bad byte table needs to not exceed the total number of saved space/bytes (i.e., predetermined redundant byte number) to avoid situations where they cannot be replaced.

In the example of FIG. 6, assuming the total number of error byte positions does not exceed the predetermined redundant byte number. As indicated by arrow A61, the memory controller 210 uses bitmap BM61 to record multiple error byte positions “PBA0”, “PBA1”, “PBA6”.

For another example, as indicated by arrow A62, the memory controller 210 establishes bad byte table T62, whose fields include: plane number and error physical address. The memory controller 210 records “PBA0”, “PBA1”, “PBA6” to the error physical address field based on multiple error byte positions “PBA0”, “PBA1”, “PBA6”, and records target plane number “1” to the plane number field.

Please return to FIG. 2, after establishing the bad byte table, in step S240, the memory controller 210 resets the plurality of physical addresses of the plurality of storage units owned by each bad block of the target plane to which the target bad block belongs according to the bad byte table. Furthermore, when writing data to the rewritable non-volatile memory module 220, in step S250, the memory controller 210 sets each reset bad block of the target plane as a normal physical block to store data. For example, the reset bad blocks may be removed from the bad block table. Furthermore, the reset bad blocks may be included in the available block pool. The available block pool is a logical concept that represents a collection of all physical blocks available for storing new data.

In this embodiment, to avoid delay caused by querying the bad byte table during the writing process, after the bad byte table is established, the memory controller 210 directly resets physical addresses of storage units of each bad block in the target plane according to the established bad byte table. All physical addresses of each minimum operation unit will skip bad byte positions and be postponed to later physical addresses, and finally will use physical addresses of good bytes/storage units in the redundant area that were saved to compensate for physical addresses that were postponed due to skipping bad byte positions.

In existing bad block management schemes, in order to improve physical block utilization, bad physical pages in bad blocks are discarded, and a good page with another physical address is mapped with the original physical block as the same logical block. Therefore, when reading and writing data in that logical block, it will jump between different physical blocks to read and write, affecting storage performance.

The provided scheme resets physical addresses of storage units of each bad block in the target plane, all physical addresses of each minimum operation unit will skip bad byte positions and be postponed to later physical addresses, allowing continuous writing and improving write efficiency.

More specifically, in the operation of resetting the plurality of physical addresses of the plurality of storage units owned by each bad block of the target plane to which the target bad block belongs according to the bad byte table, the memory controller 210 compares a plurality of physical addresses already set to the plurality of storage units and the one or more target error byte positions to obtain one or more first physical addresses corresponding to the one or more target error byte positions and a plurality of second physical addresses not corresponding to the one or more target error byte positions; and the memory controller 210 sequentially sets the plurality of second physical addresses and one or more third physical addresses to the plurality of storage units, wherein the one or more third physical addresses belong to a plurality of redundant physical addresses of a redundant area of each physical block.

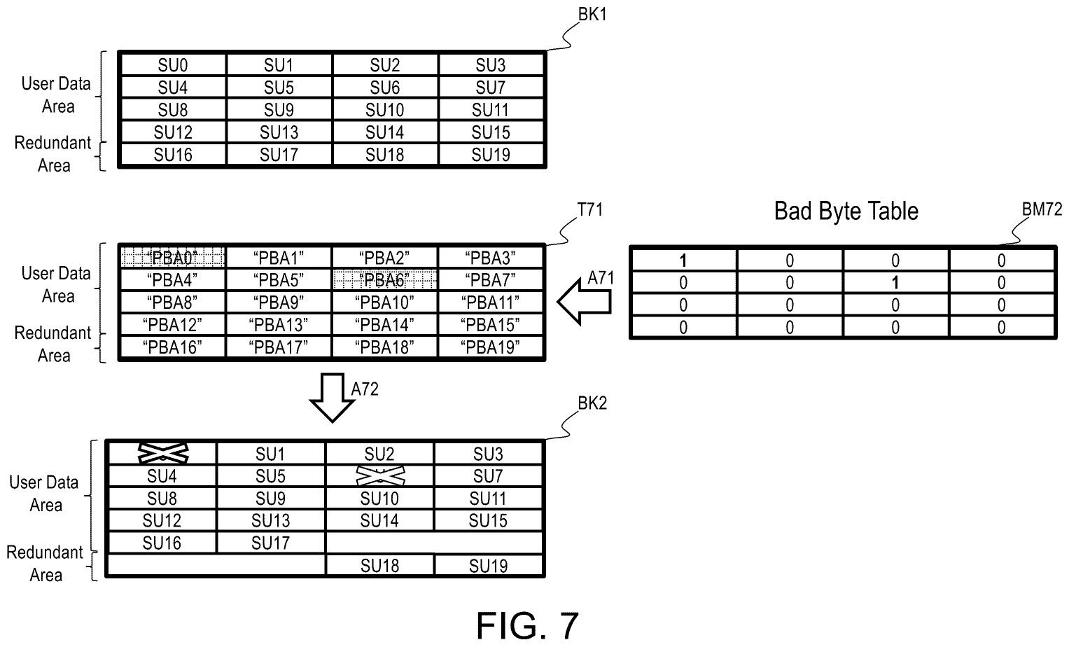

FIG. 7 is a diagram illustrating resetting physical addresses of a plurality of storage units of each bad block according to a bad byte table according to an embodiment of the present invention. For example, please refer to FIG. 7, assume a bad block BK1 in the target plane has storage units SU0-SU15 located in the user data area, and available storage units SU16-SU19 located in the redundant area. Part or all of the available storage units SU16-SU19 can be additional available (blank) storage units obtained by reducing error correction capability. Furthermore, as shown in table T71, further assume that physical addresses originally set to storage units SU0-SU19 are “PBA0”-“PBA19”, and the memory controller 210 has already established bad byte table BM72 corresponding to the target plane.

In this example, as indicated by arrow A71, based on bad byte table BM72, the memory controller 210 obtains two first physical addresses (e.g., “PBA0”, “PBA6”) corresponding to two error byte positions among physical addresses “PBA0”-“PBA19” and multiple second physical addresses (e.g., “PBA1”-“PBA5”, “PBA7”-“PBA19”) not corresponding to two error byte positions. Since the number of error byte positions is 2, the memory controller 210 will sequentially use two physical addresses “PBA16”, “PBA17” (also called third physical addresses) from the redundant area to replace first physical addresses “PBA0”, “PBA6”. That is, the corresponding two storage units SU16, SU17 in the redundant area will be included in this bad block to keep the available space of the entire bad block unchanged. It's like originally dividing SU0-SU15 as bad block BK1 for unified operation, when SU0 and SU6 are bad, postponing to include SU16 and SU17 into bad block BK1 to ensure the number of storage units in bad block BK1 remains unchanged.

That is, as indicated by arrow A72, based on bad byte table BM72, the memory controller 210, by way of postponing physical addresses, skips storage units SU0, SU6 corresponding to two error byte positions, and postpones using subsequent storage units to supplement as available storage units for that bad block BK1. For example, the first storage unit of bad block BK1 will be set as storage unit SU1, and then postpones to use two storage units SU16, SU17 originally in the redundant area. Similarly, as shown in table T72, after resetting, bad block BK1 will become bad block BK2, which has storage units SU1-SU5, SU7-SU17. However, since all storage units in the reset bad block BK2 are available, the memory controller 210 can set this bad block as a normal physical block to store data.

In another embodiment, the memory controller 210 will not reset physical addresses of multiple storage units of the physical block. The memory controller 210 will adjust physical addresses used for storing data of each storage unit of the bad block according to error byte positions identified based on the bad byte table only before using that bad block (such as before writing data to that bad block), to write data to multiple storage units with adjusted/determined physical addresses of the bad block.

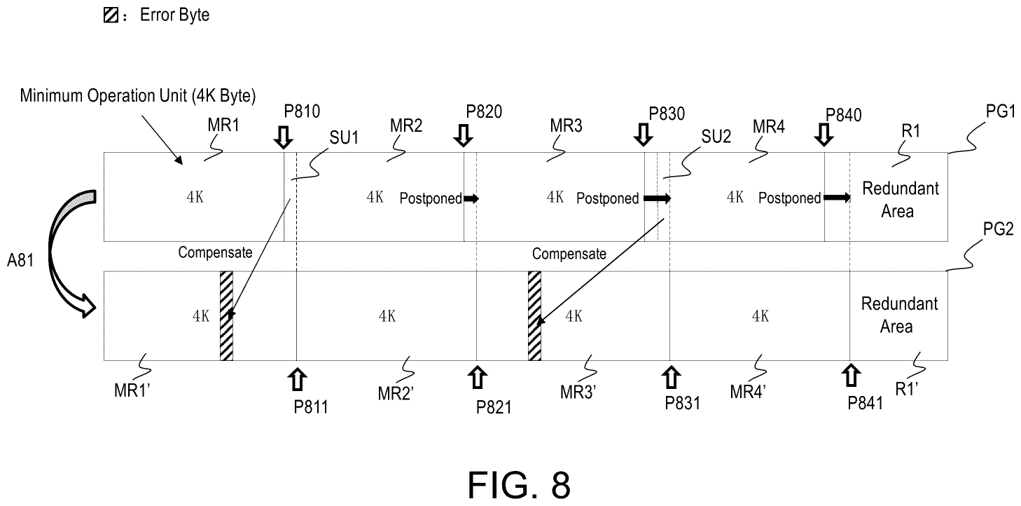

FIG. 8 is a diagram illustrating resetting physical addresses of multiple storage units of each bad page according to the bad byte table according to another embodiment of the present invention.

Error byte positions are usually also distributed in bad pages within bad blocks. For example, please refer to FIG. 8, assume a bad page PG1 in a bad block has four minimum operation (read) units MR1˜MR4 in the user data area, each 4K bytes in size, and each bad page PG1 has a redundant area R1. Furthermore, assume that after querying the bad byte table, the memory controller 210 can obtain error byte positions (as shown in gray parts in FIG. 8). To skip these error byte positions, the memory controller 210 resets storage units for bad page PG1. For example, for minimum operation unit MR1: since minimum operation unit MR1 has error bytes, to compensate for the missing storage space due to skipping error byte positions within minimum operation unit MR1, the memory controller 210 uses part of storage space SU1 from the next minimum operation unit MR2 to compensate for storage space within minimum operation unit MR1 to maintain total storage space at 4K bytes, and postpones the end position of minimum operation unit MR1 from P810 to P811 to obtain minimum operation unit MR1′.

Then, for minimum operation unit MR2: since the original storage space SU1 in minimum operation unit MR2 was used to compensate for minimum operation unit MR1, the memory controller 210 uses part of storage space from the next minimum operation unit MR3 to compensate for storage space within minimum operation unit MR2 to maintain total storage space at 4K bytes, and postpones the end position of minimum operation unit MR2 from P820 to P821 to obtain minimum operation unit MR2′.

Then, for minimum operation unit MR3: since the end position of minimum operation unit MR2 was postponed from P820 to P821, causing reduction in storage space within minimum operation unit MR3, the memory controller 210 will use part of storage space from the next minimum operation unit MR4 to compensate for the reduced part. Furthermore, since minimum operation unit MR3 has error bytes, to compensate for the missing storage space due to skipping error byte positions within minimum operation unit MR3, the memory controller 210 also uses part of storage space SU2 from the next minimum operation unit MR4 to compensate for storage space within minimum operation unit MR3. Finally, the memory controller 210 postpones the end position of minimum operation unit MR3 from P830 to P831 to obtain minimum operation unit MR3′.

Then, for minimum operation unit MR4: since the end position of minimum operation unit MR3 was postponed from P830 to P831, causing reduction in storage space within minimum operation unit MR4. To compensate for the reduced part, the memory controller 210 postpones the end position of minimum operation unit MR4 from P840 to P841 to obtain minimum operation unit MR4′, causing the redundant area R1 to be adjusted to redundant area R1′ (the starting position of the redundant area is adjusted).

After all minimum operation units have been adjusted, a reset bad page PG1′ is obtained, where all current storage space in bad page PG1′ is normal and available. Similarly, after all bad pages in the bad block have gone through this resetting process, all storage space in this bad block is normal and available, and the memory controller 210 can reset this bad block as a normal physical block (e.g., remove from bad block table), restoring its original data storage function and increasing the storage space of storage device 20.

In one embodiment, if the error byte pattern is the irregular pattern, in the operation of establishing the bad byte table according to the plurality of groups of error byte positions and the error byte pattern, the memory controller 210 counts a total number of occurrences of each error byte position in the plurality of groups of error byte positions, according to the total number of each error byte position, sorts all error byte positions in descending order; and selects at most N error byte positions from multiple sorted error byte positions to record in a bitmap corresponding to the target plane (because it needs to avoid exceeding the predetermined redundant byte number, leading to inability to be replaced) to establish the bad byte table, wherein N is a predetermined redundant byte number.

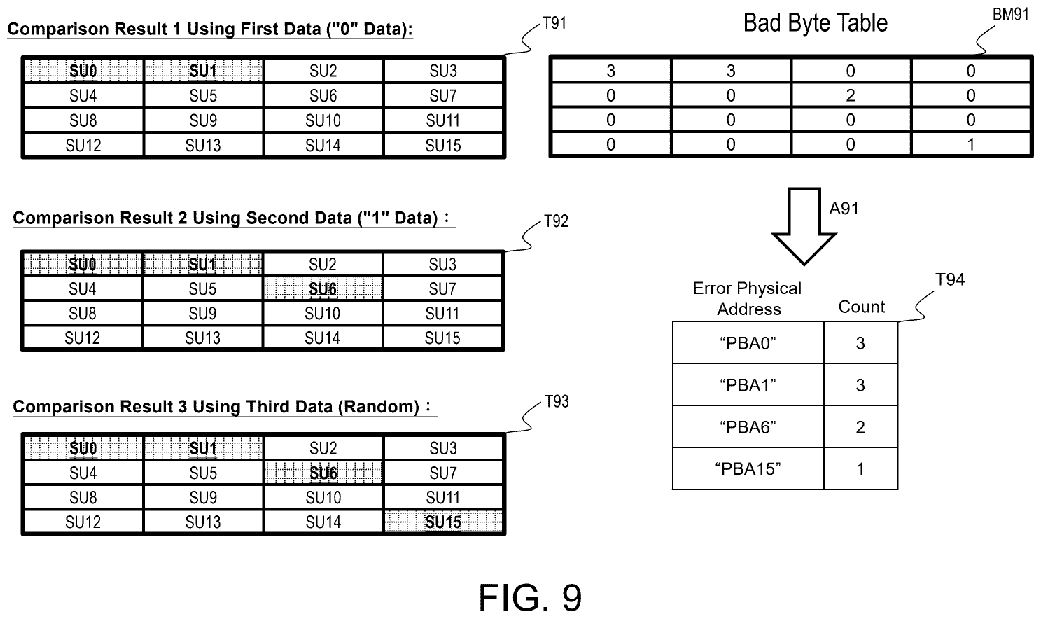

FIG. 9 is a diagram illustrating sorting error byte positions according to an embodiment of the present invention. For example, please refer to FIG. 9, in this embodiment, assume the memory controller 210 used three groups of first data with different patterns to write to the target bad block and read corresponding second data to obtain multiple comparison results (as shown in tables T91˜T93). Among them, table T91 is a comparison result obtained based on first data with all bit values being “0”, the memory controller 210 determines that data corresponding to storage units SU0, SU1 has errors, and obtains error byte positions “PBA0”, “PBA1”; table T92 is a comparison result obtained based on first data with all bit values being “1”, the memory controller 210 determines that data corresponding to storage units SU0, SU1, SU6 has errors, and obtains error byte positions “PBA0”, “PBA1”, “PBA6”; table T93 is a comparison result obtained based on first data with randomly arranged “0”, “1” bit values, the memory controller 210 determines that data corresponding to storage units SU0, SU1, SU6, SU15 has errors, and obtains error byte positions “PBA0”, “PBA1”, “PBA6”, “PBA15”.

In this example, the memory controller 210 further counted the number of occurrences (total count) of each error byte position. For example, in tables T91˜T93, error byte position “PBA0” appears 3 times; error byte position “PBA1” appears 3 times; error byte position “PBA6” appears 2 times; error byte position “PBA15” appears 1 time.

The memory controller 210 further records the total count of each error byte position to bad byte table BM91. The values recorded in multiple storage cells of multiple physical addresses of the corresponding physical block BK1 in the bad byte table are preset to 0, used to indicate non-error byte positions. In one embodiment, the memory controller 210 can directly record the total count of error byte positions to corresponding storage cells. As shown in bad byte table BM91 in FIG. 9, according to the above statistics for each error byte position, the memory controller 210 records a value of 3 to the storage cell corresponding to storage unit SU0 (physical address PBA0); records a value of 3 to the storage cell corresponding to storage unit SU1 (physical address PBA1); records a value of 2 to the storage cell corresponding to storage unit SU6 (physical address PBA6); records a value of 1 to the storage cell corresponding to storage unit SU15 (physical address PBA15).

In another embodiment, the memory controller 210 can further use a total count table to record the number of error occurrences of each error byte position (e.g., in the form of table T94).

In one embodiment, as indicated by arrow A91, the memory controller 210 sorts all error byte positions in descending order according to the total count of each error byte position (as shown in table T94).

In one embodiment, the memory controller 210 further identifies target error byte positions whose total count is greater than a first threshold among all error byte positions, and only resets physical addresses of the physical block according to the target error byte positions. In this way, the memory controller 210 can filter out relatively more reliable physical addresses (because their total number of error occurrences is lower than the first threshold). The first threshold can be determined based on the number of groups of test data written. For example, FIG. 9 uses 3 groups of test data, the first threshold can be set to 3 or 2.

Assuming in the example of FIG. 9, the first threshold is set to 3, the memory controller 210 obtains target error byte positions: “PBA0”, “PBA1”, and resets physical addresses of storage units SU0-SU15 to “PBA2”-“PBA17”.

It should be noted that in the above embodiments, because the storage unit corresponding to the physical address used to locate data is one byte, the memory controller 210 determines error “byte” positions according to storage units corresponding to physical addresses to establish bad “byte” table, but the present invention is not limited to this.

For example, in another embodiment, the storage unit corresponding to the physical address used to locate data is one physical page, so the memory controller 210 determines error “page” positions according to storage units corresponding to physical addresses to establish bad “page” table. For another example, in another embodiment, the storage unit corresponding to the physical address used to locate data is one physical sector, so the memory controller 210 determines error “sector” positions according to storage units corresponding to physical addresses to establish bad “sector” table.

That is, in another embodiment, the memory controller 210 determines error unit positions according to storage units corresponding to physical addresses to establish a bad unit table. Then, the memory controller 210 resets the plurality of physical addresses of the plurality of storage units owned by each physical block of the target plane to which the target bad block belongs based on the established bad unit table, so as to store data to one or more physical blocks in the target plane according to the reset plurality of storage units.

On the other hand, after confirming the total number of error byte positions of the target plane, if this total number is less than the predetermined redundant byte number, after completing the reset of multiple physical addresses of multiple storage units of each bad block, the storage space corresponding to unused physical addresses in the redundant area can be used to store larger error correction data, so as to enhance the data protection capability of the storage device.

That is, according to a total number of one or more fourth physical addresses that are not the one or more third physical addresses among the plurality of redundant physical addresses, the memory controller 210 upgrades a first error correction capability of each physical block of the target plane to a second error correction capability, so as to adjust a size of generated error correction data from a first size to a second size. The difference between the second size and the first size is the total number of the one or more fourth physical addresses.

In other words, after determining error byte positions of the target plane, because the number of redundant physical addresses used to replace error byte positions has been determined, the remaining fourth physical addresses can be used to store larger error correction data. Therefore, the memory controller 210 can enhance error correction capability (the capability of the executed error correction engine) to generate larger error correction data, and this larger error correction data's extra size compared to the original error correction data can be stored in the remaining fourth physical addresses. In this way, it can further strengthen the stability of data stored in physical blocks of the target plane, strengthening the storage capability of storage device 20. At the same time, it also fully utilizes all storage space.

Based on the above, the memory controller and memory management method provided by the embodiments of the present invention can find error byte positions of each physical block to establish a bad byte table, and reset a plurality of physical addresses of each physical block according to the bad byte table, so as to make the reset physical block have more stable physical addresses, thereby enhancing the stability of stored data and further avoiding the occurrence of error data, reducing the burden of error correction. Furthermore, the reset bad blocks are recycled to increase storage space. As can be seen, the present invention significantly improves the storage space utilization efficiency of the storage device and greatly enhances the overall working efficiency.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method, comprising:
selecting a target bad block of a rewritable non-volatile memory module to write first data;
obtaining second data from the target bad block and comparing the first data and the second data to determine one or more error byte positions;
establishing a bad byte table according to the one or more error byte positions;
resetting a plurality of physical addresses of a plurality of storage units owned by each bad block of a target plane to which the target bad block belongs according to the bad byte table; and
setting bad blocks of the target plane as normal physical blocks.

2. The memory management method according to claim 1, wherein the rewritable non-volatile memory module has a plurality of planes, and a target bad block is selected from each plane to establish a corresponding bad byte table.

3. The memory management method according to claim 2, wherein
the target bad block is selected by a random manner; and
content of the first data is a plurality of predetermined bit values, and the plurality of bit values are set to be one of following patterns: all being a same first value or second value; and the first value and the second value being randomly arranged.

4. The memory management method according to claim 1, wherein the method further comprises:
writing a plurality of first data with different patterns to the target bad block;
obtaining a plurality of second data corresponding to the plurality of first data from the target bad block to obtain a plurality of groups of error byte positions;
analyzing the plurality of groups of error byte positions to determine whether an error byte pattern of the target bad block is a regular pattern or an irregular pattern;
establishing the bad byte table according to the plurality of groups of error byte positions and the error byte pattern.

5. The memory management method according to claim 4, wherein the method further comprises:
determining the error byte pattern as the regular pattern if address differences between adjacent two error byte positions in each group of error byte positions are all a fixed value;
determining the error byte pattern as the irregular pattern if address differences between adjacent two error byte positions in each group of error byte positions are not a fixed value.

6. The memory management method according to claim 5, wherein the method further comprises:
if the error byte pattern is the regular pattern, establishing the bad byte table according to a first error byte position in each group of error byte positions and the fixed value.

7. The memory management method according to claim 5, wherein when the error byte pattern is the irregular pattern:
counting a total number of occurrences of each error byte position in the plurality of groups of error byte positions;
according to the total number of each error byte position, sorting all error byte positions in descending order;
selecting at most N error byte positions from a plurality of sorted error byte positions to record in a bitmap corresponding to the target plane to establish the bad byte table, wherein N is a predetermined redundant byte number.

8. The memory management method according to claim 7, wherein the method further comprises:
recording the total number of each error byte position;
obtaining one or more target error byte positions having the total number greater than a first threshold according to the bitmap and the total number of each error byte position.

9. The memory management method according to claim 1, wherein the method further comprise:
comparing a plurality of physical addresses already set to the plurality of storage units and the one or more target error byte positions to obtain one or more first physical addresses corresponding to the one or more target error byte positions and a plurality of second physical addresses not corresponding to the one or more target error byte positions; and
sequentially setting the plurality of second physical addresses and one or more third physical addresses to the plurality of storage units, wherein the one or more third physical addresses belong to a plurality of redundant physical addresses of a redundant area of each physical block.

10. The memory management method according to claim 9, wherein the method further comprises:
according to a total number of one or more fourth physical addresses that are not the one or more third physical addresses among the plurality of redundant physical addresses, upgrading a first error correction capability of each physical block of the target plane to a second error correction capability, so as to adjust a size of generated error correction data from a first size to a second size.

11. A memory controller, adapted for controlling a storage device disposed with a rewritable non-volatile memory module, wherein the memory controller comprises:
a memory interface control circuit, is configure to electrically connect to the rewritable non-volatile memory module;
a processor, electrically connected to the memory interface control circuit and a connection interface circuit of the storage device for electrically connecting to a host system;
wherein the processor is configured to:
select a target bad block of the rewritable non-volatile memory module to write first data;
obtain second data from the target bad block and compare the first data and the second data to determine one or more error byte positions;
establish a bad byte table according to the one or more error byte positions;
reset a plurality of physical addresses of a plurality of storage units owned by each bad block of a target plane to which the target bad block belongs according to the bad byte table; and
set bad blocks of the target plane as normal physical blocks.

12. The memory controller according to claim 11, wherein the rewritable non-volatile memory module has a plurality of planes, and the processor selects a target bad block from each plane to establish a corresponding bad byte table.

13. The memory controller according to claim 12, wherein
the target bad block is selected by a random manner;
content of the first data is a plurality of predetermined bit values, and the plurality of bit values are set to be one of following patterns: all being a same first value or second value; and the first value and the second value being randomly arranged.

14. The memory controller according to claim 11, wherein
the processor writes a plurality of first data with different patterns to the target bad block;
obtaining a plurality of second data corresponding to the plurality of first data from the target bad block to obtain a plurality of groups of error byte positions;
analyzing the plurality of groups of error byte positions to determine whether an error byte pattern of the target bad block is a regular pattern or an irregular pattern; and
establishing the bad byte table according to the plurality of groups of error byte positions and the error byte pattern.

15. The memory controller according to claim 14, wherein
if address differences between adjacent two error byte positions are all a fixed value, the processor determines the error byte pattern as the regular pattern; and
if address differences between adjacent two error byte positions are not a fixed value, the processor determines the error byte pattern as the irregular pattern.

16. The memory controller according to claim 15, wherein if the error byte pattern is the regular pattern:
the processor establishes the bad byte table according to a first error byte position in each group of error byte positions and the fixed value.

17. The memory controller according to claim 15, wherein if the error byte pattern is the irregular pattern:
the processor counts a total number of occurrences of each error byte position in the plurality of groups of error byte positions;
the processor, according to the total number of each error byte position, sorts all error byte positions in descending order;
the processor selects at most N error byte positions from a plurality of sorted error byte positions to record in a bitmap corresponding to the target plane to establish the bad byte table, wherein N is a predetermined redundant byte number.

18. The memory controller according to claim 17, wherein
the processor records the total number of each error byte position; and
the processor obtains one or more target error byte positions having the total number greater than a first threshold according to the bitmap and the total number of each error byte position.

19. The memory controller according to claim 11, wherein
the processor compares a plurality of physical addresses already set to the plurality of storage units and the one or more target error byte positions to obtain one or more first physical addresses corresponding to the one or more target error byte positions and a plurality of second physical addresses not corresponding to the one or more target error byte positions; and
the processor sequentially sets the plurality of second physical addresses and one or more third physical addresses to the plurality of storage units, wherein the one or more third physical addresses belong to a plurality of redundant physical addresses of a redundant area of each physical block.

20. The memory controller according to claim 19, wherein
according to a total number of one or more fourth physical addresses that are not the one or more third physical addresses among the plurality of redundant physical addresses, the processor upgrades a first error correction capability of each physical block of the target plane to a second error correction capability, so as to adjust a size of generated error correction data from a first size to a second size.
